(19) United States
(12) Patent Application Publication
(10) Pub. No.: US 2019/0075094 A1
(43) Pub. Date: Mar. 7, 2019

(54) SYSTEM AND METHOD FOR REMOTE IDENTIFICATION DURING TRANSACTION PROCESSING

(71) Applicant: The Toronto-Dominion Bank, Toronto (CA)

(72) Inventor: Malcolm CLARKE, Toronto (CA)

(73) Assignee: The Toronto-Dominion Bank, Toronto (CA)

(21) Appl. No.: 16/123,573

(22) Filed: Sep. 6, 2018

Related U.S. Application Data
(60) Provisional application No. 62/555,148, filed on Sep. 7, 2017.

(51) Int. Cl. H04L 29/06; G06Q 20/38; G06Q 20/40

(52) U.S. Cl. CPC H04L 63/08; H04L 63/0428; G06Q 20/4014; G06Q 20/385

(57) ABSTRACT

In one aspect, there may be provided a computing system. The computing system may include a communications module and a processor coupled to the communications module. The computing system may include a memory coupled to the processor and storing processor-executable instructions which, when executed, configure the processor to: receive, via the communications module, a signal representing a transaction processing request for a transaction initiated at a requesting system, the transaction processing requesting including transaction data; authenticate a session associated with the transaction processing request using a credential associated with an account; during the authenticated session, obtain profile data associated with the account and sending the profile data to the requesting system via the communications module; and during the authenticated session, perform transaction processing based on the transaction data and send transaction status data to the requesting system based on the transaction processing.

The present application claims priority to U.S. provisional application No. 62/555,148 filed Sep. 7, 2017, the contents of which are hereby incorporated by reference in their entirety.

### TECHNICAL FIELD

The present application relates to systems that process transactions over a network and, more particularly, to methods and systems for securely releasing profile data to a computing system during transaction processing.

### BACKGROUND

A transaction occurs when value is transferred or is committed to be transferred between various records in one or more databases. Transactions may, for example, occur in electronic commerce environments in which a record associated with a consumer may be debited and a record associated with a merchant may be credited. In such environments, a client device associated with a consumer may interact with a server associated with a merchant over a network such as the Internet and the client device may manually input a shipping address and other identifying information using an input device in order to create a profile at the server.

### BRIEF DESCRIPTION OF THE DRAWINGS

Embodiments are described in detail below, with reference to the following drawings:

FIG. 1 is a schematic diagram illustrating an example transaction and identity system;

FIG. 2 is a high-level operation diagram of an example computing device;

FIG. 3 depicts an example simplified software organization of the example computing device of FIG. 2;

FIG. 4 is a sequence diagram depicting communications that facilitate the provision of profile data, exemplary of an embodiment;

FIGS. 5 to 13 are example display screens in accordance with example embodiments;

FIG. 14 is an example flowchart of a method of providing profile data during transaction processing; and

FIGS. 15 and 16 are example display screens in accordance with example embodiments of the present disclosure.

Like reference numerals are used in the drawings to denote like elements and features.

### DETAILED DESCRIPTION OF VARIOUS EMBODIMENTS

In one aspect, there may be provided a computing system. The computing system may include a communications module and a processor coupled to the communications module. The computing system may include a memory coupled to the processor and storing processor-executable instructions which, when executed, configure the processor to: receive, via the communications module, a signal representing a transaction processing request for a transaction initiated at a requesting system, the transaction processing requesting including transaction data; authenticate a session associated with the transaction processing request using a credential associated with an account; during the authenticated session, obtain profile data associated with the account and sending the profile data to the requesting system via the communications module; and during the authenticated session, perform transaction processing based on the transaction data and send transaction status data to the requesting system based on the transaction processing.

In some implementations, the profile data may include one or more of: a name, a mailing address, a telephone number, an employer identity, an email address, a date of birth, a communication preference, a gender, or a title.

In some implementations, the requesting system may be configured to create a profile in memory associated with the requesting system based on the profile data.

In some implementations, the transaction status data may include a payment token associated with a primary account number.

In some implementations, performing transaction processing based on the transaction data and sending transaction status data to the requesting system based on the transaction processing may include determining that a transaction cannot be completed. The transaction status data may be an indication that the transaction cannot be completed.

In some implementations, the instructions may further configure the processor to: during the authenticated session, prior to sending the profile data to the requesting system, receive a signal representing a consent input via the communications module, and wherein sending the profile data is performed in response to determining, based on the consent input, that consent has been received.

In some implementations, the instructions may further configure the processor to store a record of the signal representing consent in a log identifying the profile data.

In some implementations, the instructions may further configure the processor to, during the authenticated session, send a signal representing transaction completion data to a client device associated with the authenticated session.

In some implementations, obtaining profile data associated with the account may include obtaining profile data from a permissioned blockchain network.

In some implementations, the signal representing the transaction processing request may be receiving from the requesting system.

In some implementations, the signal representing the transaction processing request may be received from a client device and the client device may be configured to send the signal representing the transaction processing request after receiving a transaction initiation request from the requesting system.

In another aspect, there may be described a method of providing profile data. The method may include: receiving a signal representing a transaction processing request for a transaction initiated at a requesting system, the transaction processing requesting including transaction data; authenticating a session associated with the transaction processing request using a credential associated with an account; during the authenticated session, obtaining profile data associated with the account and sending the profile data to the requesting system; and during the authenticated session, performing transaction processing based on the transaction data and sending transaction status data to the requesting system based on the transaction processing.

In some implementations, the profile data includes one or more of: a name, a mailing address, a telephone number, an employer identity, an email address, a date of birth, a communication preference, a gender, or a title.

In some implementations, the requesting system may be configured to create a profile in memory associated with the requesting system based on the profile data.

In some implementations, the transaction status data may include a payment token associated with a primary account number.

In some implementations, performing transaction processing based on the transaction data and sending transaction status data to the requesting system based on the transaction processing may include: determining that a transaction cannot be completed, and wherein the transaction status data is an indication that the transaction cannot be completed.

In some implementations, the method may further include: during the authenticated session, prior to sending the profile data to the requesting system, receive a signal representing a consent input, and wherein sending the profile data is performed in response to determining, based on the consent input, that consent has been received.

In some implementations, the method may further include storing a record of the signal representing consent in a log identifying the profile data.

In some implementations, the method may further include, during the authenticated session, sending a signal representing transaction completion data to a computing device associated with the authenticated session.

In another aspect, there may be described a non-transitory computer-readable storage medium comprising computer-executable instructions which, when executed, configure a processor to perform a method described herein.

In another aspect, there may be described a non-transitory computer-readable storage medium comprising computer-executable instructions which, when executed, configure a processor to: receive a signal representing a transaction processing request for a transaction initiated at a requesting system, the transaction processing requesting including transaction data; authenticate a session associated with the transaction processing request using a credential associated with an account; during the authenticated session, obtain profile data associated with the account and sending the profile data to the requesting system; and during the authenticated session, perform transaction processing based on the transaction data and send transaction status data to the requesting system based on the transaction processing.

In at least some embodiments, systems and methods are described which provide profile data to a requesting system while processing a transaction associated with that requesting system. That is, the profile data may be provided by a transaction processing system without requiring direct input of the profile data through an input device. Techniques described herein may, in at least some instances, be referred to as automatic session completion since a virtual cart or other session may be completed automatically without direct input of identifying data to a requesting system, such as an electronic commerce server. Conveniently, techniques described herein may be used to reduce computing requirements associated with a checkout process and/or registration process.

In some implementations, the systems and methods described herein may allow a requesting system to automatically create a profile for a user during transaction processing. Automatic profile creation may, for example, allow for pre-transaction communications to be anonymous or pseudo-anonymous. For example, a server such as an electronic commerce server, may interact with a remote computing device and may allow the remote computing device to complete a session (e.g., to checkout on an electronic commerce server) while remaining anonymous to the server right up until the time of transaction processing. A session completion command, such as a checkout command, may be received from an anonymous user (e.g., a user that does not already have a profile at the server) and the session may be completed without requiring direct input through an input device of profile data, such as a name, address, contact information etc. From the point of view of the server (e.g., the electronic commerce server), the session may be completed automatically in the sense that the client device need not directly provide identification information for a user. For example, an anonymous user may populate a virtual shopping cart and may then select a single interface element (e.g., a checkout button) to process a payment and provide identification information.

Conveniently, automatic session completion may reduce the use of computing resources required for electronic commerce systems and may simplify the design of such platforms. For example, a server may complete a session, such as a checkout session, without having to cooperate with a counter-party computing device to display fields for receiving an input of profile data. Profile data may, instead, be received during transaction processing directly from a transaction processing system, such as a financial system. Such direct receipt of profile data may, for example, reduce the use of processing cycles, display resources and/or bandwidth on a computing system such as on the server or a remote computing device interacting with the server.

Furthermore, automatic session completion may enhance the security of profile data and reduce the chance of interception of such data by malicious parties. Using automated session completion techniques described herein, profile data may be exchanged securely since communications between the transaction processing system that provides the profile data and the requesting system (e.g., an electronic commerce server) that receives the data may be encrypted. This may offer benefits over at least some existing systems in which profile data is received from a user via a form on a web page and sent from a user's computing device in an unencrypted format over the Internet.

Additionally, automatic session completion (which may be referred to as automatic checkout in some implementations or which may be referred to as automatic identification during transaction processing) may reduce fraudulent or malicious transactions since identity verification and transaction verification are effectively linked. Furthermore, automatic session completion may allow for greater security of profile data since it may allow for only partial release of profile data. For example, a transaction may be completed without sharing a name of a party associated with the transaction. For example, an address may be shared (e.g., for shipping purposes) but a name may be withheld and not shared with a requesting system, such as an electronic commerce server.

Additionally or alternatively, automatic session completion may be used to obviate the need to login to a web server. For example, a web server may maintain a profile or preferences for past users but may allow for session completion without requiring a login. Instead, the web server may rely on profile data received during transaction processing to identify an appropriate profile. For example, the web server may use the profile data received during transaction processing to look up an associated profile or preference maintained by the web server. This may allow for automatic logon to web servers during transaction processing without requiring credentials (such as a username and password) to be passed directly to the web server.

Additionally or alternatively, automatic session completion may be used to facilitate the updating of profile data stored at a server, such as a web server. The web server may obtain profile data during transaction processing and may automatically compare such profile data to stored profile data. If the received profile data is different from the stored profile data, the web server may, automatically or in response to user input confirming the modification, update the stored profile data based on the received profile data. For example, an address may be updated based on the received profile data so that user input of a new address is not required.

While electronic commerce servers are referenced in some example embodiments described herein, techniques described herein may be used with some systems that are not electronic commerce systems. For example, a requesting system which initiates a transaction may be a communication device, such as a mobile device, being used by a recipient for a peer-to-peer transaction.

Some or all of the above features may be provided by some embodiments.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

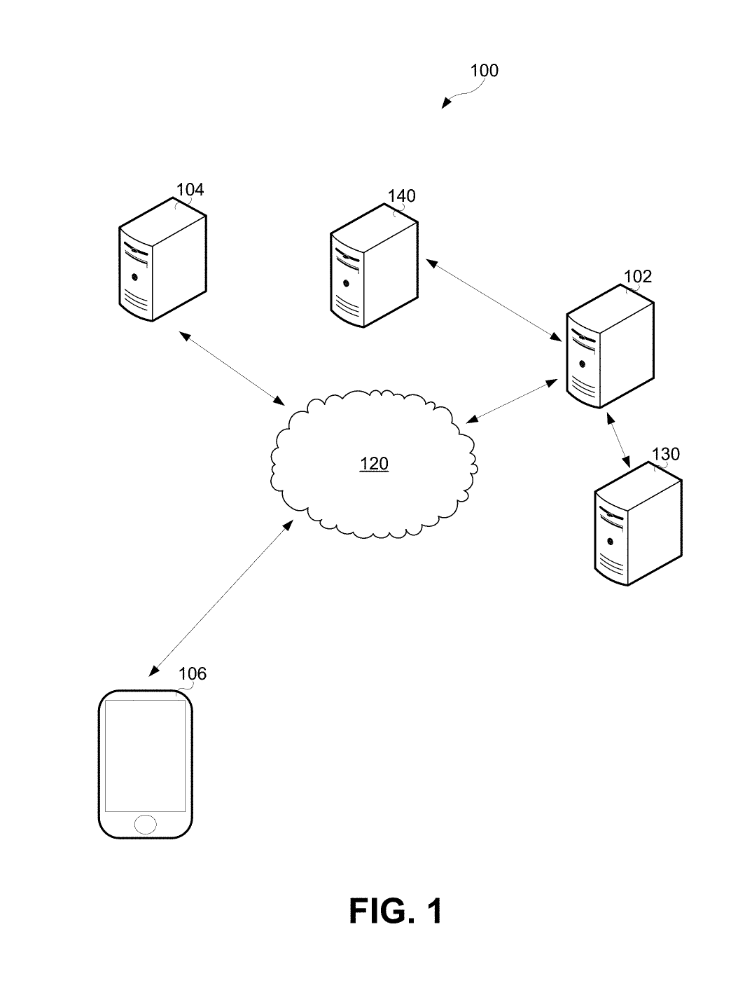

FIG. 1 is a block diagram illustrating an operating environment of an example embodiment. Various components cooperate to provide a transaction and identity system 100 which may be used, for example, to provide automatic session completion. For example, the transaction and identity system 100 may be used to allow profile data to be provided from a transaction processing system 102 to a requesting system 104 during transaction processing. The requesting system 104 may, for example, be a web server such as an electronic commerce web server.

The requesting system 104 may be any electronic device or computing device that issues or initiates a transaction processing request. The transaction processing request is a request to process a transaction, such as a request to process an exchange of value for a transaction. The transaction request may be a request to modify a value in a database. The value may, for example, represent an account balance. For example, the transaction processing request may be a payment request which requests an increase to a value in an account for a database.

The requesting system 104 may be a web server which allows computing systems, such as a client device 106, to access the requesting system 104 via a network 120. The network may, for example, include a public network such as the Internet and/or a private network. In at least some embodiments, the requesting system 104 is an electronic commerce server that serves web pages that allow another computing system to cause goods or services to be purchased. For example, the requesting system 104 may include a goods or services database that includes product or service details for products or services available for purchase. The goods or services database may, for example, include produce or service pricing information, product or service specifications, product photographs, product or services reviews, or other product or service information. The requesting system 104 may generate web pages based on the goods or services database that include interface elements, such as buttons or the like, that allow products or services to be purchased.

The requesting system 104 may, for example, generate and send a graphical user interface to a client device 106. The graphical user interface may, for example, be provided in the form of a web page, such as an HTML page, and may include a button or other interface element to initiate session completion. For example, the interface element may be a check-out button or another interface element for inputting a command to proceed to a transaction processing operation. For example, an instant checkout button may be displayed on the client device 106 based on the graphical user interface provided by the requesting system 104.

The requesting system 104 may have stored thereon an application which includes computer-executable instructions that causes the requesting system 104 to perform one or more functions described herein.

The transaction and identity system 100 also includes a client device 106. The client device is an electronic device that is or includes a computing device. The client device 106 may be or include any one of: a desktop computer, a laptop computer, a personal computer, a tablet computer, a notebook computer, a hand-held computer, a personal digital assistant, a kiosk, a portable navigation device, a mobile phone, a smart phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The client device 106 may include an application for facilitating interactions between the client device 106 and the requesting system 104. The application may, for example, be or include a web browser. The application includes computer-executable instructions that causes the client device 106 to interact with the requesting system 104.

The client device 106 may include an application for facilitating interactions with a transaction processing system 102. By way of example, the application may be a banking application. The application includes computer-executable instructions that causes the client device 106 to interact with the transaction processing system 102. For example, the application may allow the client device 106 to receive authentication data such as a credential and transmit the authentication data to the transaction processing system 102 for authentication of a session. By way of further example, the application may allow the client device 106 to receive and send instructions to the transaction processing system 102 to authorize a transaction (e.g., to authorize the transfer of value between records in one or more databases) and/or to authorize the release of profile data.

While a single client device 106 is illustrated in FIG. 1, in other embodiments, more than one client device 106 may be used. For example, a first client device may be used for communications with the requesting system 104 and a second client device may be used for communications with the transaction processing system 102.

The transaction and identity system 100 includes a transaction processing system 102. The transaction processing system 102 is an electronic device and, more particularly, is a computing system. Computing systems may be or include, for example, a mainframe computer, a minicomputer, or the like. Computing systems may include one or more computing devices. For example, a computing system may include multiple computing devices such as, for example, database servers, compute servers, and the like. The multiple computing devices may be in communication using a computer network. For example, computing devices may communicate using a local-area network (LAN). In some embodiments, computer systems may include multiple computing devices organized in a tiered arrangement. For example, a computer system may include middle-tier and back-end computing devices. In some embodiments, a computer system may be a cluster formed of a plurality of interoperating computing devices.

The transaction processing system 102 includes an application that includes computer-executable instructions that configure the transaction processing system 102 to perform one or more functions described herein. Such functions may, for example, include communicating with the requesting system 104 and/or a client device 106 to process a transaction and provide profile data to the requesting system 104.

In at least some embodiments, the transaction processing system 102 may communicate with further systems or subsystems in order to provide such functions. For example, the transaction processing system 102 may communicate with a digital identity network 130 to retrieve profile data.

The digital identity network 130 is illustrated with a single block but it may be a network consisting of numerous computer systems. For example, the digital identity network may be a blockchain network which includes a number of nodes. The blockchain network is a decentralized peer-to-peer network in which nodes may maintain respective copies of an append-only ledger.

The blockchain network may be a permissioned blockchain network in which only authorized nodes are permitted to add blocks to the blockchain. For example, only verified nodes may be granted permission to write to the blockchain. The verified nodes may be trusted nodes such as nodes associated with government organizations or other trusted entities such as banks. By way of example, the verified nodes may be associated with a driver's license bureau, a credit bureau, a government identity issuing office such as a passport office or birth registry office, or an office of another type. Given ones of these nodes may maintain identity records of various types. For example, a node associated with a passport office may maintain digital passport records, a node associated with a driver's license bureau may maintain digital licensing records, a node associated with a credit bureau may maintain digital credit records, and a node associated with a bank may maintain digital banking records. Various verified nodes may maintain contact information records which may, for example, specify an email address, postal address, telephone number, or other type of contact information.

Accordingly, at least some verified nodes may write to the blockchain. At least some of the blocks written to the blockchain may be related to profile data, which may also be referred to as digital identity data. The digital identity network 130 may store digital identity data associated with a plurality of users. In at least some embodiments, digital identity data representing personal information may not be included in the blockchain. Instead, the blocks may store a private secret that is related to such digital identity data. The private secret may act as proof to the existence of the digital identity data and may be used to verify the authenticity of the data. For example, in at least some embodiments, the private secret may be a hash of the digital identity data such that, when the digital identity data is received from another system (i.e., a system apart from the verified node maintaining the digital identity data), it may be verified from the hash stored in a block on the blockchain. For example, in retrieving digital identity data from the digital identity network 130, the transaction processing system 102 may obtain the digital identity data from another system and may use the data on the blockchain to verify such data.

The blockchain network may, for example, be implemented using Hyperledger Fabric, for example. It will, however, be appreciated that the blockchain network may take other forms.

Profile data may be stored in other ways instead of or in addition to the digital identity network 130. For example, in at least some embodiments, the transaction processing system 102 may be associated with a data store that stores profile data for clients or customers associated with the transaction processing system. For example, the transaction processing system 102 may be operated by a bank or other financial institution and the data store may store profiles for customers of the bank or other financial institution.

Accordingly, the transaction processing system 102 may retrieve profile data from the digital identity network 130 and/or from a data store associated with the transaction processing system 102. Similarly, the transaction processing system 102 may rely on one or more systems during transaction processing. For example, the transaction processing system 102 may communicate with a transaction support system 140. The transaction support system 140 may, for example, be or include a payment rails system. The payment rails system may be a computing system associated with a payment provider, such as a credit card provider. In at least some embodiments, the transaction support system 140 may include or be associated with a tokenization system which may, for example, tokenize a personal account number (PAN) to be used for payment processing. In other embodiments, the transaction processing system 102 may not be used and, instead, the transaction processing system 102 may complete transaction processing using resources associated with the transaction processing system 102, such as an account associated with the transaction processing system 102.

FIG. 1 illustrates an example representation of components of the transaction and identity system 100. The transaction and identity system 100 can, however, be implemented differently than the example of FIG. 1. For example, various components that are illustrated as separate systems in FIG. 1 may be implemented on a common system. By way of further example, the functions of a single component may be divided into multiple components.

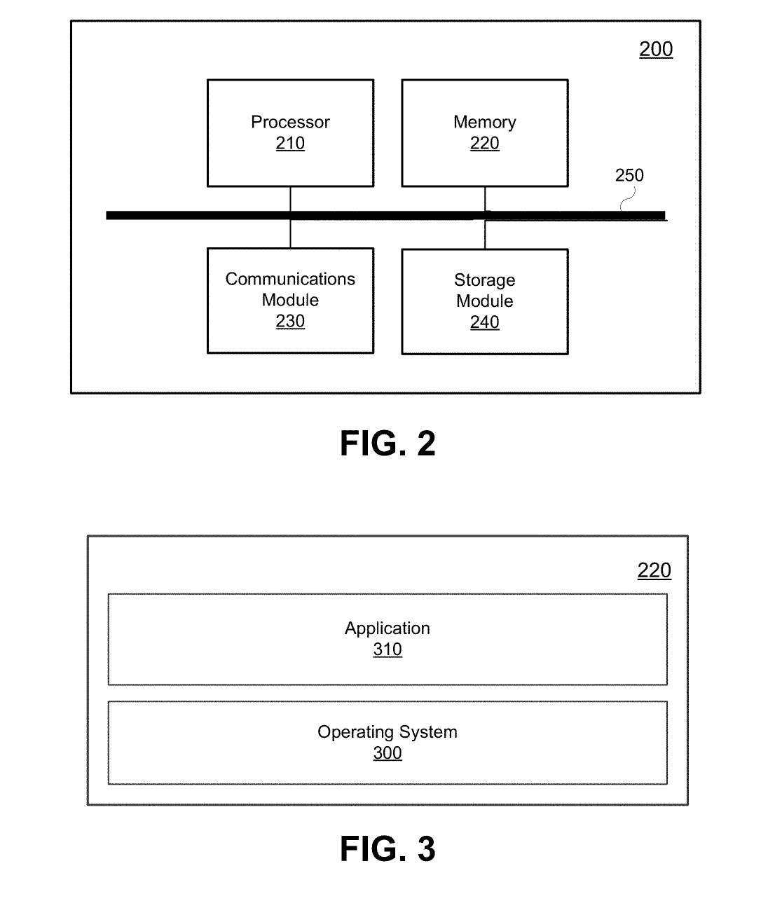

FIG. 2 is a high-level operation diagram of an example computing device 200. The example computing device 200 may be exemplary of one or more of the requesting system 104, client device 106, transaction processing system 102, transaction support system 140, and the digital identity network 130 (or a portion thereof, such as a node associated with the digital identity network 130).

The example computing device 200 may be exemplary of one or more of the requesting system 104, client device 106, transaction processing system 102, transaction support system 140, and the digital identity network 130 (or a portion thereof, such as a node associated with the digital identity network 130) may include software that adapts it to perform a particular function. More particularly, software of each of the security computing device 200. The example computing device 200 may be exemplary of one or more of the requesting system 104, client device 106, transaction processing system 102, transaction support system 140, and/or the digital identity network 130 (or a portion thereof, such as a node associated with the digital identity network 130) cooperates in provide profile data during transaction processing.

The example computing device 200 includes a variety of modules. For example, as illustrated, the example computing device 200 may include a processor 210, a memory 220, a communications module 230, and a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are each a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the example computing device 200 to communicate using near-field communication (NFC), via Wi-Fi (™), using Bluetooth (™) or via some combination of one or more networks or protocols. In some embodiments, all or a portion of the communications module 230 may be integrated into a component of the example computing device 200. For example, the communications module may be integrated into a communications chipset.

The storage module 240 allows data at the example computing device 200 to be stored and retrieved. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally or alternatively, the storage module 240 may access data stored remotely such as, for example, as may be accessed using a local area network (LAN) and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the example computing device 200. As illustrated these software components include an operating system 300 and an application 310.

The operating system 300 is software. The operating system 300 allows the application 310 to access the processor 210, the memory 220, and the communications module 230. The operating system 300 may be, for example, UNIX (™), Linux (™), Microsoft (™) Windows (™), Apple OSX (™) or the like.

The application 310 adapts the example computing device 200, in combination with the operating system 300, to operate as a device to a particular function. For example, the application 310 may cooperate with the operating system 300 to adapt a suitable embodiment of the example computing device 200 to operate as the computing device 200. The example computing device 200 may be exemplary of one or more of the requesting system 104, client device 106, transaction processing system 102, transaction support system 140, and/or the digital identity network 130.

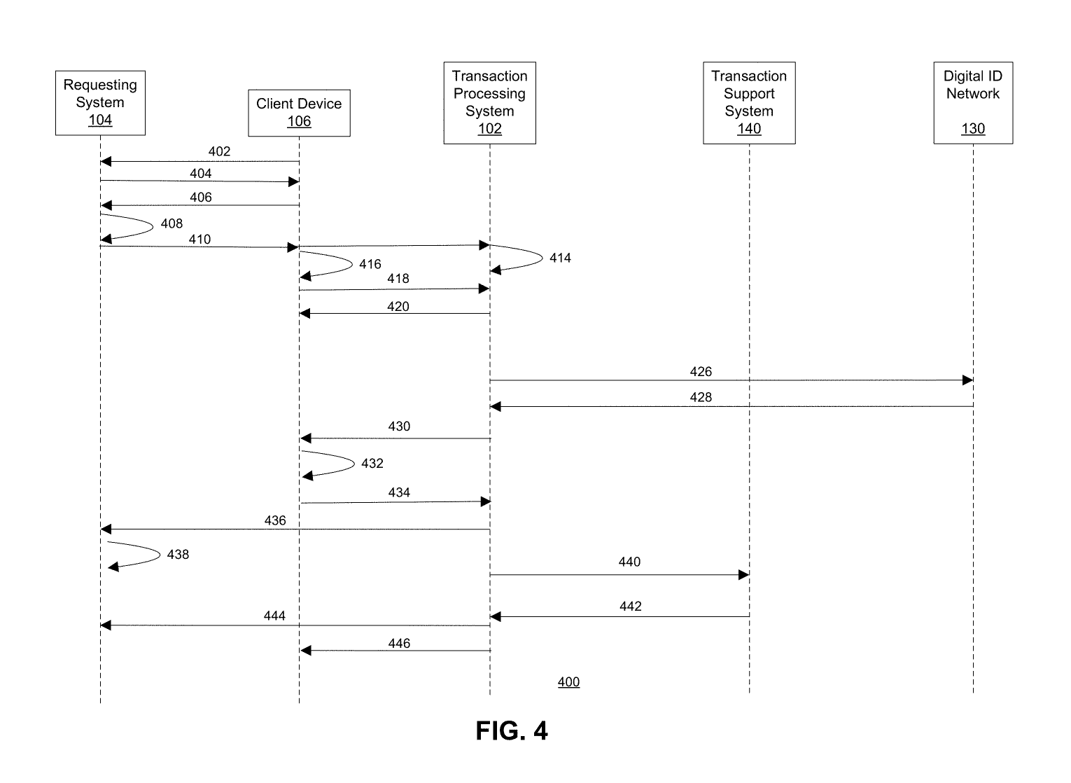

FIG. 4 illustrates a sequence diagram 400, similar to a Unified Modelling Language (UML) sequence diagram, that shows how various components of the transaction and identity system 100 cooperate to share profile data while processing a transaction

In the following description of the sequence diagram 400, discussion is made of various messages being sent and received. In some embodiments, the exchanged messages may be implemented as messages. However, in other embodiments, some or all of the illustrated messages may not correspond to messages per se but may instead be implemented using techniques such as for example remote procedure call (RPC) and/or web services application programming interfaces (APIs). For example, it may be that the various message pairs illustrated in FIG. 4 correspond, respectively, to an RPC or a web service API call and a reply or callback in response to that call. The messages of the sequence diagram may be provided as signals.

Operations described with reference to the sequence diagram 400 may be included in one or more methods that may be performed by one or more components of the transaction and identity system 100. For example, computer-executable instructions stored on the requesting system 104 may configure a processor associated with the requesting system 104 to perform all or a portion of the operations that are described below as occurring on the requesting system 104. Similarly, computer-executable instructions stored on the client device 106 may configure a processor associated with the client device 106 to perform all or a portion of the operations that are described below as occurring on the client device 106. Similarly, computer-executable instructions stored on the transaction processing system 102 may configure a processor associated with the transaction processing system 102 to perform all or a portion of the operations that are described below as occurring on the transaction processing system 102. Operations (or a portion of such operations) described below as being performed by the requesting system 104 may form a method, operations (or a portion of such operations) described below as being performed by the client device 106 may form a further method, operations (or a portion of such operations) described below as being performed by the transaction processing system 102 may form a further method, and operations (or a portion of such operations) described below as being performed by the transaction support system 140 may form a further method.

The sequence diagram 400 of FIG. 4 may illustrate a sequence for use with electronic commerce operations, for example. That is, the requesting system 104 may be a web server which may administer an electronic commerce platform. Prior to performance of the operations illustrated in the sequence diagram 400, a client device 106 may access an electronic commerce or other platform provided by the requesting system 104. The client device 106 may, for example, request one or more webpages served by the requesting system 104. For example, the client device 106 may request a webpage associated with a uniform resource locator (URL) and the requesting system 104 may send the webpage to the client device 106. The client device 106 and the requesting system 104 may continue to interact to allow the client device 106 to add one or more items, such as a product or service, to a virtual shopping cart. In at least some embodiments, the client device 106 may add the goods to the shopping cart in an anonymous manner. That is, the requesting system 104 may not associate the client device 106 with a stored profile and may allow the client device 106 to interact with the requesting system 104 in a logged-out state. For example, the client device 106 may not provide credentials or other authorization data to the requesting system 104.

In some embodiments, the requesting system 104 may not be a web server that serves web pages but may instead serve data that is to be presented within a standalone application, such as an electronic commerce application.

Accordingly, the sequence illustrated in the sequence diagram 400 may begin after one or more items have already been selected and/or added to a virtual shopping cart on the requesting system 104. The sequence may also begin at a state when a user of a client device 106 has an existing account at a transaction processing system 102 and has established one or more credentials that are associated with that account.

As illustrated, at the beginning of the sequence a client device 106 sends a message 402 to the requesting system 104. The message 402 may be referred to as a completion command, a transaction initialization command or an instant checkout command. The request may indicate to the requesting system 104 that the client device 106 is ready to complete a session. For example, the request may indicate that the client device 106 is ready to begin processing of a transaction. The transaction may be associated with a virtual shopping cart, for example, which may be stored in memory associated with the requesting system 104 and which may identify one or more products or services.

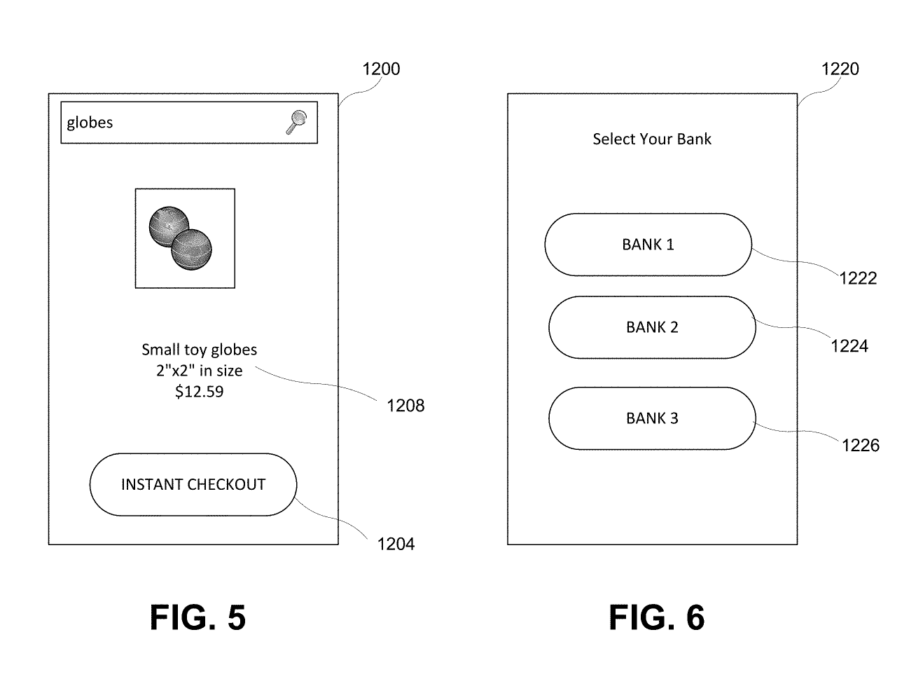

Referring briefly to FIG. 5, prior to receiving the message 402, the client device 106 may display a display screen 1200 which includes a selectable option 1204 to send the message 402. The selectable option 1204 may be a selectable option to issue a completion command, a transaction initialization command or an instant checkout command. The selectable option 1204 is an interface element that may be selected or otherwise activated through an input interface associated with the client device 106 and the message 402 may be sent after input at the selectable option 1204 to send the message 402 is detected.

The display screen 1200 may be displayed based on data received from the requesting system 104. For example, the requesting system may provide data used to prepare the display screen 1200 or it may provide the display screen 1200 itself (e.g., as an HTML or other page).

The display screen 1200 may include associated data 1208 for a product or service associated with the transaction. For example, a photograph of the product, a description of the product and/or a price of the product may be included.

Referring again to FIG. 4, the requesting system 104 receives the message 402. In at least some embodiments, after receiving the message 402, the requesting system 104 may prepare and send a message 404 to the client device 106. The message 404 is a request to select a transaction provider. In response to receiving the message 404, the client device 106 may display a display screen based on the message 404. Referring briefly to FIG. 6, an example display screen 1220 is illustrated. The example display screen 1220 includes selectable options 1222, 1224, 1226 to select a transaction service provider. The selectable options 1222, 1224, 1226 may be selected using an input interface associated with the client device 106.

Referring again to FIG. 4, in at least some embodiments, in response to receiving a selection of one of the selectable options 1222, 1224, 1226 selecting a transaction provider, the client device 106 sends a message 406 to the requesting system 104. The message 406 indicates the selected transaction provider and the message 406 may be received, for example, while the client device 106 remains anonymous or pseudo anonymous to the requesting system 104 in the sense that the client device 106 may have not logged in to the requesting system 104.

Furthermore, after receiving the message 402 and, in at least some embodiments, the message 406, the requesting system prepares a transaction processing request at 408. The transaction processing request may include transaction data such as, for example, product or service identifying information (such as an SKU), pricing information (which may include, for example, a total cost, a pre-tax cost, a tax cost and/or a shipping cost). The transaction data may also include a transaction identifier and/or a requesting system identifier. The transaction data may, in some embodiments, include a product photograph and/or product or service specifications. The transaction identifier may be a unique identifier used by the transaction processing system 102 to return information to the requesting system 104. The requesting system identifier may identify the requesting system to the transaction processing system 102.

A message 410 is sent by the requesting system 104 to the transaction processing system 102. The message 410 may be sent through the client device 106, in some embodiments. That is, the requesting system 104 may send a message 410 to the client device 106 which may then send a message to the transaction processing system 102. In other embodiments, the message 410 may be sent directly from the requesting system 104 to the transaction processing system 102. The message 410 is sent to a transaction processing system 102 associated with the selected transaction processor (e.g., to the transaction processing system 102 associated with the transaction processor indicated in the message 406). The message 410 includes a transaction processing request. The transaction processing request includes the transaction data. The transaction processing request may, in at least some embodiments, include profile data type information. The profile data type information may specify one or more types of profile data that the requesting system is requesting. For example, the requesting system 104 may request that a mailing address and an email address be provided.

The transaction processing system 102 may, upon receiving the transaction processing request, store data associated with the transaction processing request in memory. For example, the transaction data may be stored in memory associated with the transaction processing system 102 at 414.

Furthermore, in response to receiving the transaction processing request, the client device 106 may cooperate with the transaction processing system 102 to authenticate a user. For example, at 416, the client device may obtain one or more credentials from a user. The credentials may include, for example, a username, a password, a PIN, biometric data such as a fingerprint, or credentials of another type.

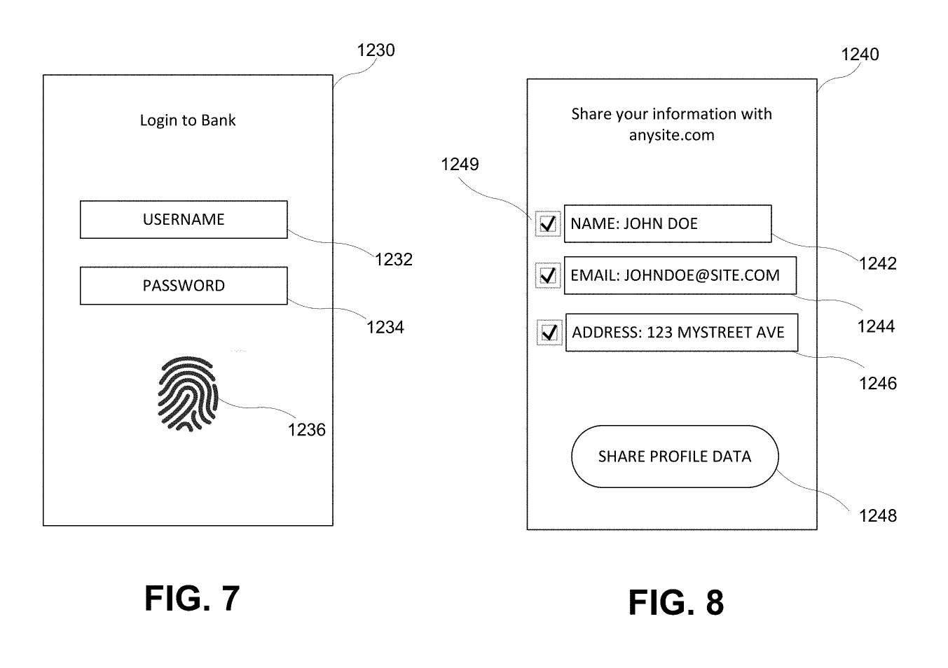

Referring briefly to FIG. 7, an example display screen 1230 that may be displayed by a client device 106 at 416 is illustrated. The display screen 1230 prompts for input of credentials and may include one or more fields 1232, 1234 for receiving a username and/or password and/or one or more elements 1236 for receiving or prompting for the receipt of a fingerprint or other biometric data.

Referring again to FIG. 4, after one or more credentials are received at the client device 106, the client device 106 sends a message 418 to the transaction processing system 102. The message 418 may include the credential or a representation of the credential and the message 418 may be sent in an encrypted format, for example. The transaction processing system 102 may receive the message 418 and may authenticate the session based on the received message 418. For example, the transaction processing system 102 may compare the credential or the representation of the credential or other information provided in the received message 418 to stored data to identify an account associated with the session and to determine that the session has been approved by the account holder.

It may be noted that the authentication may be performed by the client device 106 and the transaction processing system 102 without involvement by the requesting system 104. That is, the client device 106 is not required to provide credentials to the requesting system 104.

If the session is authenticated, the transaction processing system 102 may send an authentication acknowledgment message 420 to the client device 106.

During the authenticated session, the transaction processing system 102 may obtain profile data associated with the account associated with the credentials. The profile data may be obtained from a data store associated with the transaction processing system 102 and/or may be obtained from a digital identity network 130. For example, a message 426 may be sent by the transaction processing system 102 to the digital identity network 130 to request the profile data. In response to sending the message 426, the digital identity network 130 (or a particular computing system associated therewith) may retrieve the profile data and may send the profile data to the transaction processing system 102 in a message 428. The digital identity network 130 may be a permissioned blockchain network and so the profile data may be obtained from or based on a permissioned blockchain network. In some embodiments, the profile data may be obtained based on profile data type information included in the transaction processing request. That is, profile data of a type corresponding to the profile data type information may be obtained by the transaction processing system 102.

The profile data may include personal information associated with a user such as, one or more of: a name, a mailing address, a telephone number, an employer identity, an email address, a date of birth, a communication preference, a gender, or a title. Other type of profile data may be included in other embodiments instead of or in addition to the profile data described above.

After the transaction processing system 102 has obtained the profile data, the transaction processing system 102 may send the profile data or a portion thereof to the client device 106 in a message 430.

The client device 106 may, at 432, generate a prompt to request consent input. The prompt may be provided on a display screen 1240, an example of which is illustrated in FIG. 8. The display screen 1240 may display profile data 1242, 1244, 1246 such as, for example, a name, email address, mailing address, etc. In at least some embodiments, the profile data that is displayed on the display screen 1240 may be profile data of one or more types that were specified by the requesting system 104. For example, the transaction processing request in the message 410 may have included profile data type information specifying one or more types of profile data that the requesting system 104 is to receive and the display screen 1240 may include profile data of the requested type(s).

The display screen 1240 includes a selectable option 1248 to share profile data. The selectable option 1248 may be used to input consent to share the profile data with the requesting system 104.

In at least some embodiments, various profile data items are selectable in order to control whether or not that item is to be shared. For example, the display screen 1240 of FIG. 8 includes a toggle switch 1249 adjacent to each item of the profile data and the toggle switch controls whether the associated item will be shared.

When the selectable option 1248 to input consent is activated, the client device 106 sends a message 434 to the transaction processing system 102. The message 434 includes an indication of consent which represents the consent input.

In response to receiving the indication of consent and during the authenticated session, the transaction processing system 102 sends the profile data to the requesting system 104 in a message 436. To send the message 436, the transaction processing system 102 may rely on a transaction identifier and/or a requesting system identifier received in the message 410. For example, the transaction processing system 102 may identify a requesting system to send the message 436 to based on the requesting system identifier and may include the transaction identifier in the message 436 to allow the requesting system 104 to associate the message 436 with a particular session. The transaction processing system 102 may also store a record of the consent in a log that also identifies the profile data to provide an audit trail indicating that consent was provided prior to release of the profile data.

The requesting system 104 receives the profile data and, in response, processes the profile data at 438. The processing of the profile data may take a variety of forms and may, for example, include decryption of the profile data. For example, the requesting system 104 may automatically create a profile at the requesting system 104 based on the profile data. For example, the requesting system 104 may store the profile data in memory. That is, the requesting system 104 may create an account for the user at the requesting system 104. While the account may store the profile data, it may be noted that the profile data was obtained without direct entry of the profile data by the client device into the requesting system 104. For example, a shipping address may be obtained without requiring the user to input the shipping address using an input interface of the client device 106.

The storing of profile data at the requesting system 104 may be automatic or in response to user input requesting such storage.

The processing of the profile data at 438 may also include determining, based on the profile data, that the profile data is associated with an existing account at the requesting system 104. That is, the requesting system may determine, by matching the received profile data with a stored profile for an account previously created at the requesting system 104, that an account has already been created. Then, the requesting system 104 may login to the identified account and/or may associate the present transaction with the identified account. For example, the identified account may be updated with the transaction data for the present transaction.

The processing of the profile data at 438 may also include determining, based on the profile data, that a profile stored at the requesting system 104 needs updating. For example, the requesting system 104 may determine that the profile data includes new or modified information that is not included in the profile stored at the requesting system 104. In response to making such a determination, the requesting system 104 may update the profile or account at the requesting system 104 based on the new or modified profile data.

The transaction processing system 102 may also, during the authenticated session, perform transaction processing based on the transaction data. The transaction processing may take a number of forms.

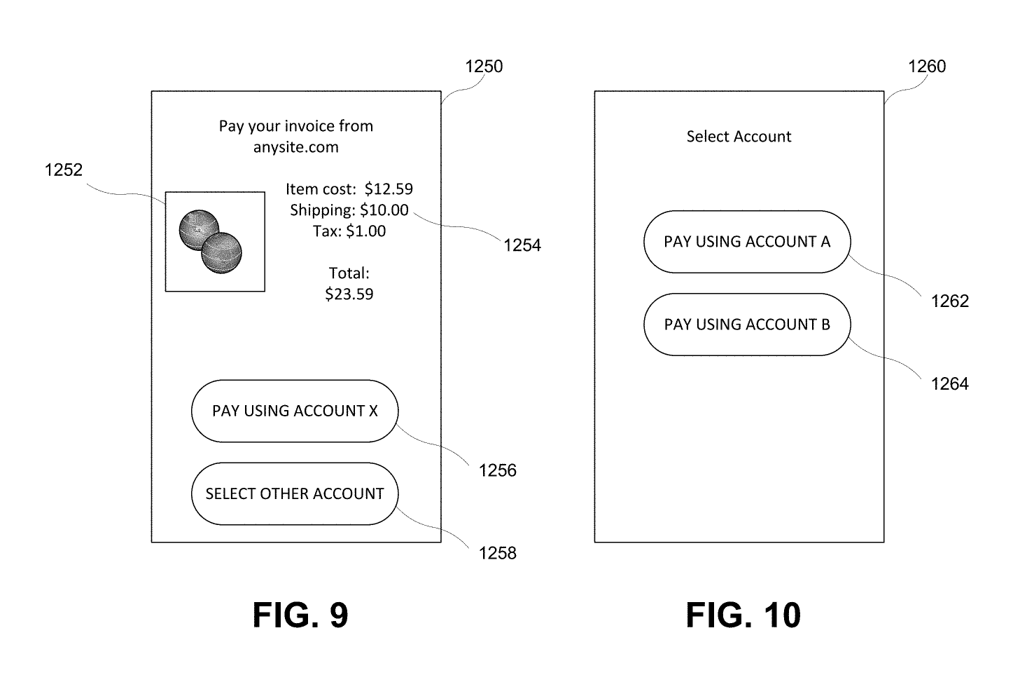

Referring briefly to FIG. 9, in at least some embodiments, in order to perform transaction processing, the transaction processing system 102 may cooperate with the client device 106 to cause the client device 106 to display a display screen 1250 that requests payment approval input. The display screen 1250 may include transaction data, such as a photograph 1252, pricing data 1254, etc. In some embodiments, the pricing data may include a shipping price and the shipping price may be determined, by the requesting system 104, based on an address provided in the profile data. For example, after the profile data has been provided by the transaction processing system 102 to the requesting system 104, the requesting system 104 may use the profile data to generate a shipping price. The requesting system 104 may send the shipping price and/or a total that includes the shipping price to the transaction processing system 102 in a message (not shown) and the transaction processing system 102 may use the shipping price and/or the total when processing the transaction. For example, the display screen 1250 may include the shipping price and the total.

The display screen 1250 includes one or more selectable options 1256, 1258 to complete the transaction. For example, a first selectable option 1256 is an option to complete the transaction with a default account and a second selectable option 1258 is an option to select an alternate account. In response to selecting the second selectable option 1258 a further display screen 1260 (FIG. 10) may be displayed which includes selectable options 1262, 1264 to select an account.

Accordingly, the transaction processing system 102 may also, during the authenticated session, perform transaction processing based on the transaction data. In doing so, the transaction processing system 102 may rely on one or more transaction support systems 140. For example, the transaction processing system 102 may send a message 440 to the transaction support system 140 to request, for example, a tokenized version of a primary account number (PAN). For example, the transaction processing system 102 may be or include a tokenization service provider which tokenizes the PAN to create a payment token. The payment token may be sent from the transaction support system 140 to the transaction processing system 102 in a message 442.

The transaction processing system 102 may, during the authenticated session, send transaction status data to the requesting system 104 based on the transaction processing. For example, the transaction status data may be sent in a message 444. The transaction status data may, for example, include a payment token associated with a primary account number. The payment token may, for example, be used to obtain payment through a payment rail, such as a credit card provider.

In some instances, in performing transaction processing based on the transaction data, the transaction processing system 102 may determine that a transaction cannot be completed. This may occur, for example, where an account does not have a sufficient balance or credit to complete the transaction. When the transaction cannot be completed, the transaction processing system 102 may send to the requesting system 104 transaction status data that is an indication that the transaction cannot be completed.

The transaction status data may, in at least some instances, indicate that the transaction has been successful.

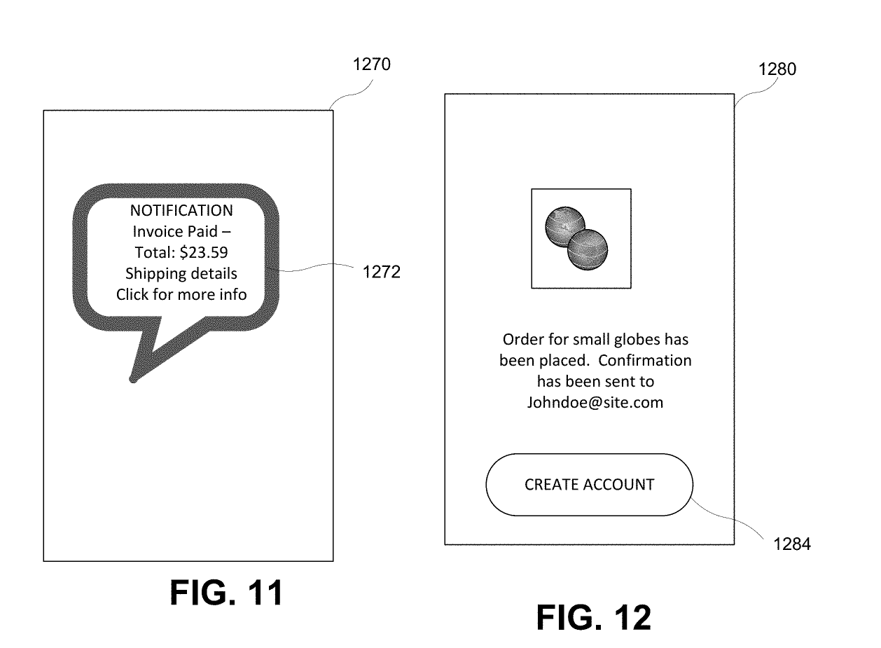

In at least some embodiments, the transaction processing system 102 may also send a message 446 to the client device 106 during the authenticated session. The message 446 may represent transaction completion data to notify the client device 106 of transaction status. The transaction completion data may, for example, indicate that the transaction was successfully completed and an example of transaction completion data 1272 is illustrated in the example display screen 1270 of FIG. 11. To send the message 446, the transaction processing system 102 may rely on a transaction identifier and/or a requesting system identifier received in the message 410. For example, the transaction processing system 102 may identify a requesting system to send the message 446 to based on the requesting system identifier and may include the transaction identifier in the message 446 to allow the requesting system 104 to associate the message 446 with a particular session.

Referring now to FIG. 12, in at least some embodiments, after profile data is received at the requesting system 104, the requesting system 104 may interact with the client device 106 to display, on the client device 106, a display screen 1280 that includes a selectable option 1284 to create an account. The selectable option 1284 may be triggered to cause an account to be created at the requesting system. That is, a profile may be created at the requesting system based on the received profile data. In some embodiments, when the selectable option 1284 is selected, the requesting system 104 may request input of a credential that is to be used for logging into the requesting system in the future. The display screen 1280 may be displayed at the end of the sequence or at another point during the sequence such as, for example, at operation 438.

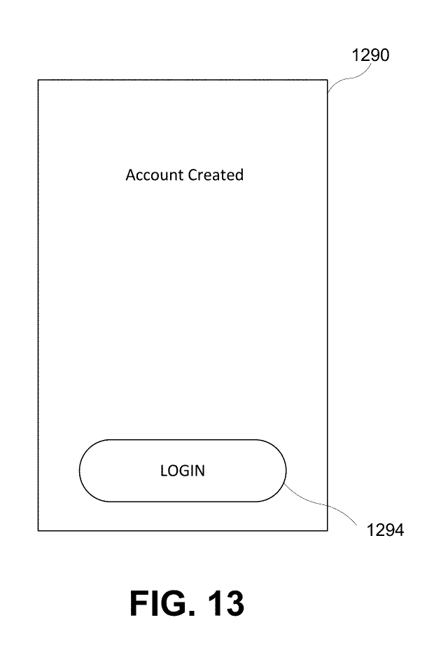

Referring to FIG. 13, after an account has been created, the requesting system 104 may allow the client device 106 to login to the account with a selectable option 1294 for logging in provided on a display screen 1290.

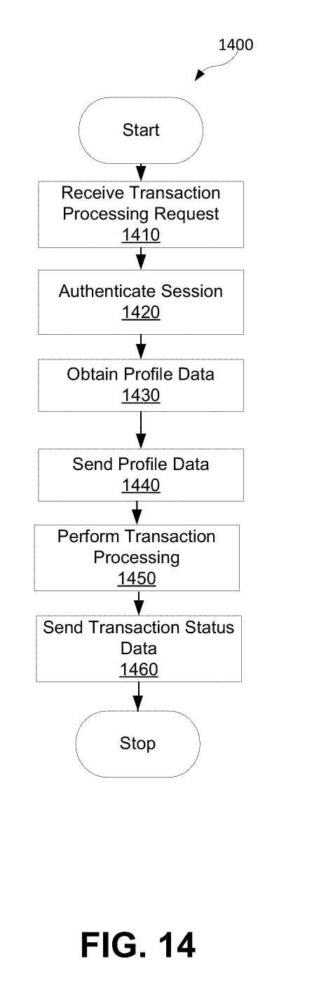

Reference will now be made to FIG. 14 which illustrates a flowchart of a method 1400. Operations 1410 and onward are performed by one or more processors of a computing device, such as, for example, the processor 210 of a suitably configured instance of the example computing device 200, executing software such as, for example, a suitable instance of the application 310. The method 1400 may be performed by the transaction processing system 102.

At the operation 1410, the transaction processing system receives, via the communications module, a signal representing a transaction processing request for a transaction initiated at a requesting system. The transaction processing requesting includes transaction data such as, for example, product or service identifying information (such as an SKU), pricing information (which may include, for example, a total cost, a pre-tax cost, a tax cost and/or a shipping cost). The transaction data may also include a transaction identifier and/or a requesting system identifier. The transaction data may, in some embodiments, include a product photograph and/or product or service specifications. The transaction data may be a unique identifier used by the transaction processing system 102 to return information to the requesting system 104. For example, the transaction data may include a transaction identifier and/or a requesting system identifier. The transaction processing request may also, in at least some embodiments, specify profile data type information which identifies one or more type(s) of profile data sought by the requesting system 104. The transaction processing request may also, in at least some embodiments, specify one or more profile data types.

The signal representing the transaction processing request may, in some embodiments, be received at the transaction processing system from the requesting system 104. The requesting system 104 may be of a type described herein such as, for example, a web server providing an electronic commerce site.

In other embodiments, the signal representing the transaction processing request may be received from a client device. The client device is a device operated by a user. In at least some embodiments, the client device is configured to send the signal representing the transaction processing request after receiving a transaction initiation request from the requesting system. That is, the requesting system 104 may send a signal, which may be referred to as a transaction initiation request, to the client device which may in turn send the transaction processing request to the transaction processing system.

After receiving the transaction processing request, the transaction processing system begins a session (which may be unauthenticated until authentication is performed as described below and may store session parameters such as the received transaction data including, for example, the transaction identifier and/or the requesting system identifier.

Control flow then proceeds to operation 1420. At operation 1420, the transaction processing system authenticates a session associated with the transaction processing request using a credential associated with an account. The credential may include, for example, any one or more of a username, password, PIN, and/or biometric data. The transaction processing system may, at operation 1420, verify the authenticity of the credential and may identify an account associated with the credential. Upon successful authentication of the credential(s) the session becomes an authenticated session.

Control flow then proceeds to operation 1430 in which the transaction processing system 102, during the authenticated session, obtains profile data associated with the account and (at operation 1440) sends the profile data to the requesting system via a communications module. The profile data may, for example, include one or more of: a name, a mailing address, a telephone number, an employer identity, an email address, a date of birth, a communication preference, a gender, or a title. Other types of profile data may be used instead of or in addition to the profile data described above.

The transaction processing system 102 may obtain profile data from a digital identify network 130 and/or from another data store. For example, in some embodiments, obtaining profile data associated with the account includes obtaining profile data from a permissioned blockchain network.

In sending the profile data, the transaction processing system 102 may retrieve and use the transaction identifier and/or a requesting system identifier that was received in the transaction processing request. For example, the requesting system identifier may be used to identify the requesting system 104 to which the profile data is to be sent and the transaction identifier may be used to allow the requesting system to associate the profile data with a particular session.

The profile data is sent via a communications module and may be sent in an encrypted format. For example, the requesting system 104 and the transaction processing system may have previously established keys to facilitate encrypted communications.

The requesting system 104 may be configured to create a profile in memory associated with the requesting system based on the profile data. Accordingly, a profile data may be created with identification data or other profile data without requiring direct input of such data.

In at least some embodiments, prior to sending the profile data to the requesting system, the transaction processing system may obtain consent to do so. For example, the transaction processing system 102 may receive a signal representing a consent input via the communications module, and the sending of the profile data may be performed in response to determining, based on the consent input, that consent has been received. The transaction processing system 102 may store a record of the signal representing consent in a log identifying the profile data.

Control flow then proceeds to operation 1450 in which, during the authenticated session, the transaction processing system performs transaction processing based on the transaction data and (at operation 1460) sends transaction status data to the requesting system based on the transaction processing. The transaction status data may, for example, include a payment token associated with a primary account number. The payment token may be an authenticated or an unauthenticated payment token. In some instances, the payment token may be used by the requesting system to clear a transaction.

In some instances, it may not be possible to complete a transaction. For example, in performing transaction processing based on the transaction data and sending transaction status data to the requesting system based on the transaction processing comprises, the transaction processing system may determine that a transaction cannot be completed. When the transaction processing system 102 determines that the transaction cannot be completed, it the transaction status data sent by the transaction processing system 102 to the requesting system 104 may be an indication that the transaction cannot be completed. It may be noted, however, that even where a transaction fails, the requesting system 104 may obtain the profile data.

The transaction processing system 102 may also send to the client device 106 a signal representing transaction completion data to a computing device associated with the authenticated session. That is, the transaction processing system 102 may also notify the client device 106 of the status. Techniques such as those described above with reference to FIG. 11 may, for example, be used.

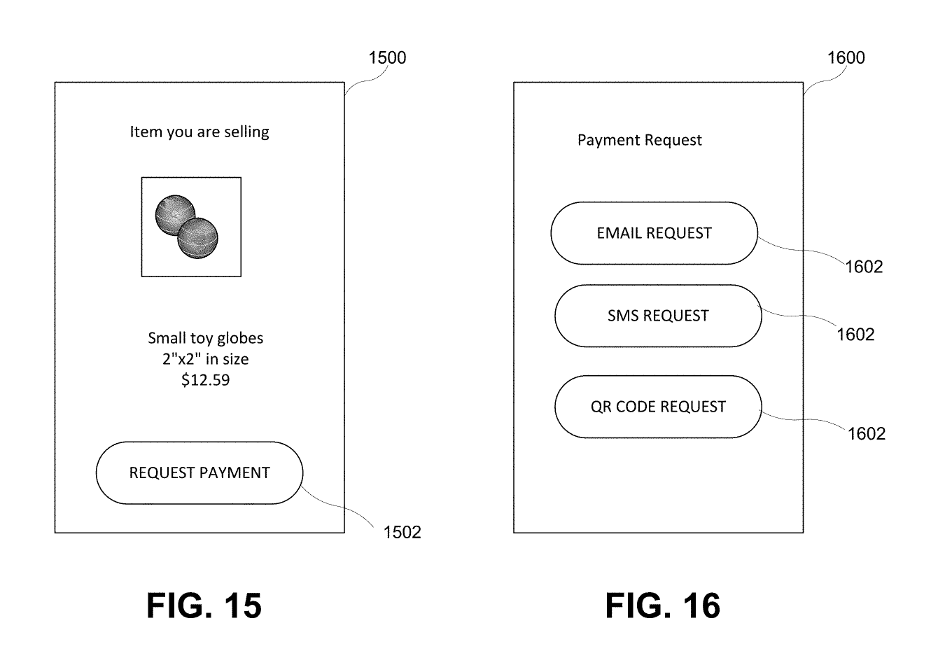

The techniques described above may be used to provide profile data in other systems apart from electronic commerce systems. For example, techniques described herein may be used with peer-to-peer transactions. By way of example, a peer-to-peer transaction may occur when the requesting system 104 and the client device 106 are both associated with individuals. The individuals may, for example, be attempting to process a transaction. By way of example, in some embodiments, the transaction might occur when the individual associated with the requesting system 104 sells something to the individual associated with the client device 106 and requests payment. Referring now to FIG. 15, an example display screen 1500 is illustrated. The example display screen may be displayed on the requesting system 104 and may include a selectable option 1502 for issuing a transaction initiation request. The transaction initiation request is a request to process a transaction.

In some embodiments, in response to receiving a selection of the selectable option 1502 for issuing a transaction initiation request, the requesting system 104 may send the transaction initiation request to the client device 106. The transaction initiation request may be sent using any one of a number of techniques including, for example, by email, SMS, instant message, an in-application message, a near field communication message, through a machine readable code such as a QR code, etc. Referring now to FIG. 16, in some embodiments, the requesting system 104 may display a display 1600 that includes a plurality of selectable options 1602 for inputting a communication type. For example, the selectable options 1602 may allow a user of the requesting system 104 to specify the technique that is to be used to send the transaction initiation request to the client device 106. Some of these techniques may require an address or number that is to be used; for example, a phone number to be used for SMS. The transaction initiation request may, for example, include transaction data of the type described above.

Upon receiving the transaction imitation request, the client device 106 may send a transaction processing request of the type described above to the transaction processing system 102 and the transaction processing system may process the request as described above. For example, the transaction processing system may, after authenticating the session, obtain and send profile data and transaction status data to the requesting system 104. The requesting system may, for example, display the profile data.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted certain adaptations and modifications of the described embodiments can be made. Therefore, the above discussed embodiments are considered to be illustrative and not restrictive.

What is claimed is:

1. A computing system comprising:
a communications module;
a processor coupled to the communications module; and
a memory coupled to the processor and storing processor-executable instructions which, when executed, configure the processor to:
receive, via the communications module, a signal representing a transaction processing request for a transaction initiated at a requesting system, the transaction processing requesting including transaction data;
authenticate a session associated with the transaction processing request using a credential associated with an account;
during the authenticated session, obtain profile data associated with the account and send the profile data to the requesting system via the communications module; and
during the authenticated session, perform transaction processing based on the transaction data and send transaction status data to the requesting system based on the transaction processing.

2. The computing system of claim 1, wherein the profile data includes one or more of: a name, a mailing address, a telephone number, an employer identity, an email address, a date of birth, a communication preference, a gender, and a title.

3. The computing system of claim 1, wherein the requesting system is configured to create a profile in memory associated with the requesting system based on the profile data.

4. The computing system of claim 1, wherein the transaction status data includes a payment token associated with a primary account number.

5. The computing system of claim 1, wherein performing transaction processing based on the transaction data and sending transaction status data to the requesting system based on the transaction processing comprises:
determining that the transaction cannot be completed,
and wherein the transaction status data is an indication that the transaction cannot be completed.

6. The computing system of claim 1, wherein the instructions further configure the processor to:
during the authenticated session, prior to sending the profile data to the requesting system, receive a signal representing a consent input via the communications module,
and wherein sending the profile data is performed in response to determining, based on the consent input, that consent has been received.

7. The computing system of claim 6, wherein the instructions further configure the processor to:
store a record of the consent in a log identifying the profile data.

8. The computing system of claim 1, wherein the instructions further configure the processor to:
during the authenticated session, send a signal representing transaction completion data to a client device associated with the authenticated session.

9. The computing system of claim 1, wherein obtaining profile data associated with the account includes obtaining profile data from a permissioned blockchain network.

10. The computing system of claim 1, wherein the signal representing the transaction processing request is receiving from the requesting system.

11. The computing system of claim 1, wherein the signal representing the transaction processing request is received from a client device and wherein the client device is configured to send the signal representing the transaction processing request after receiving a transaction initiation request from the requesting system.

12. A method of providing profile data, the method comprising:
receiving a signal representing a transaction processing request for a transaction initiated at a requesting system, the transaction processing requesting including transaction data;
authenticating a session associated with the transaction processing request using a credential associated with an account;
during the authenticated session, obtaining profile data associated with the account and sending the profile data to the requesting system; and
during the authenticated session, performing transaction processing based on the transaction data and sending transaction status data to the requesting system based on the transaction processing.

13. The method of claim 12, wherein the profile data includes one or more of: a name, a mailing address, a telephone number, an employer identity, an email address, a date of birth, a communication preference, a gender, and a title.

14. The method of claim 12, wherein the requesting system is configured to create a profile in memory associated with the requesting system based on the profile data.

15. The method of claim 12, wherein the transaction status data includes a payment token associated with a primary account number.

16. The method of claim 12, wherein performing transaction processing based on the transaction data and sending transaction status data to the requesting system based on the transaction processing comprises:
determining that the transaction cannot be completed,
and wherein the transaction status data is an indication that the transaction cannot be completed.

17. The method of claim 12, further comprising:
during the authenticated session, prior to sending the profile data to the requesting system, receive a signal representing a consent input,
and wherein sending the profile data is performed in response to determining, based on the consent input, that consent has been received.

18. The method of claim 17, further comprising:
storing a record of the consent in a log identifying the profile data.

19. The method of claim 12, further comprising:
during the authenticated session, sending a signal representing transaction completion data to a computing device associated with the authenticated session.

20. A non-transitory computer-readable storage medium comprising computer-executable instructions which, when executed, configure a processor to:
receive a signal representing a transaction processing request for a transaction initiated at a requesting system, the transaction processing requesting including transaction data;
authenticate a session associated with the transaction processing request using a credential associated with an account;
during the authenticated session, obtain profile data associated with the account and sending the profile data to the requesting system; and
during the authenticated session, perform transaction processing based on the transaction data and send transaction status data to the requesting system based on the transaction processing.
